(19) United States
(12) Patent Application Publication
(10) Pub. No.: US 2026/0243916 A1
(43) Pub. Date: Aug. 20, 2026

(54) REDUCED MOTION EFFECTS OF NUCLEAR MAGNETIC RESONANCE (NMR) ECHO DATA USING MACHINE LEARNING IN WELL SYSTEMS

(71) Applicant: Halliburton Energy Services, Inc., Houston, TX (US)

(72) Inventors: Yunke Liu, Houston, TX (US); Rebecca Jachmann, Houston, TX (US); Boguslaw Wiecek, Houston, TX (US); Jie Yang, Houston, TX (US)

(21) Appl. No.: 19/056,553

(22) Filed: Feb. 18, 2025

(51) Int. Cl. G01V 3/32; E21B 47/12; E21B 49/00

(52) U.S. Cl. CPC G01V 3/32; E21B 49/00; E21B 47/12; E21B 2200/22

(57) ABSTRACT

Systems, methods, and apparatus, including computer programs encoded on computer-readable media, for obtaining nuclear magnetic resonance (NMR) measurements of a subsurface formation in a well system. NMR echo data having motion artifacts may be determined in response to performing downhole NMR measurements using an NMR tool of the well system. Motion data may be determined from one or more downhole well devices of the well system. The motion data may indicate a motion downhole of the NMR tool. The NMR echo data having motion artifacts and the motion data may be provided as inputs to a trained machine learning system to reduce the motion artifacts of the NMR echo data. Output NMR echo data having reduced motion artifacts may be obtained from an output of the trained machine learning system. Properties of the subsurface formation may be determined from the NMR echo data having reduced motion artifacts.

### TECHNICAL FIELD

The present invention relates generally to oil and gas systems and services, and more specifically to reduced motion effects of nuclear magnetic resonance (NMR) echo data using machine learning in well systems.

### BACKGROUND

The oil and gas services industry uses various types of well equipment and tools in well systems at well sites. Well systems may use nuclear magnetic resonance (NMR) tools for NMR logging of the subsurface formation of a well for hydrocarbon reservoir evaluation. For example, the NMR logging may indicate various properties of the subsurface formation, such as the volume (e.g., porosity) and distribution (e.g., permeability) of the rock pore space, the rock composition, the type and quality of the fluids (e.g., water and hydrocarbons), and hydrocarbon producibility. NMR measurement data, such as NMR echo data, obtained from the NMR tool during NMR logging is sensitive to the motion of the NMR tool. For example, when the NMR tool is used in a logging while drilling (LWD) or a measurement while drilling (MWD) context, the longitudinal and lateral displacement due to the motion of the NMR tool can distort or introduce motion artifacts or noise into the NMR echo data. Since the motion of the NMR tool can distort or corrupt the NMR echo data, the analysis of the corrupted NMR echo data can result in the determination of inaccurate properties of the subsurface formation unless the corrupted NMR echo data is processed to reduce the motion artifacts.

### BRIEF DESCRIPTION OF THE DRAWINGS

FIG. 1 depicts a schematic diagram of an example well system including a nuclear magnetic resonance (NMR) tool, according to some implementations.

FIG. 2 depicts a workflow of example operations for reducing motion artifacts from NMR echo data, according to some implementations.

FIG. 3A depicts example diagrams of motion displacement profiles, according to some implementations.

FIG. 3B depicts an example signal diagram of NMR echo data with motion artifacts, according to some implementations.

FIG. 3C depicts an example signal diagram of NMR echo data with reduced motion artifacts, according to some implementations.

FIG. 3D depicts an example signal diagram of spectrum data after inversion, according to some implementations.

FIG. 3E depicts an example signal diagram of a two-dimensional signal measured across multiple wait times (WT) with corresponding Carr-Purcell-Meiboom-Gill (CPMG) measurements, according to some implementations.

FIG. 3F depicts an example signal diagram of the two-dimensional signal of spectrum data after inversion, according to some implementation.

FIG. 4 depicts a functional block diagram of an example Variational Autoencoder (VAE) generative neural network, according to some implementations.

FIG. 5 depicts a functional block diagram of an example Generative Adversarial Network (GAN) neural network, according to some implementations.

FIG. 6 is a flowchart of example operations for obtaining NMR measurements of a subsurface formation in a well system, according to some implementations.

FIG. 7 depicts an example computer system of a well system for performing NMR measurements of a subsurface formation, according to some implementations.

FIG. 8 shows an example well system that includes the NMR tool in a wireline logging environment, according to some implementations.

FIG. 9 shows an example well system that includes an NMR tool in a drilling environment, according to some implementations.

FIG. 10 is a diagram of an example NMR magnet and antenna(s) configuration, according to some implementations.

### DESCRIPTION

The description that follows includes example systems, methods, techniques, and program flows that describe aspects of the disclosure. However, it is understood that this disclosure may be practiced without these specific details. For instance, this disclosure refers to certain well systems, devices, or tools in illustrative examples. Aspects of this disclosure can be instead applied to other types of well systems, devices, and tools. In other instances, well-known instruction instances, protocols, structures, and techniques have not been shown in detail to avoid confusion.

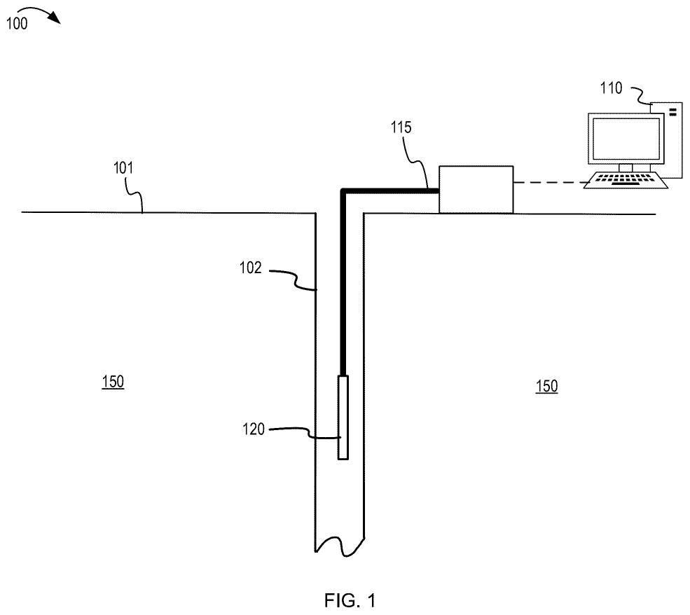

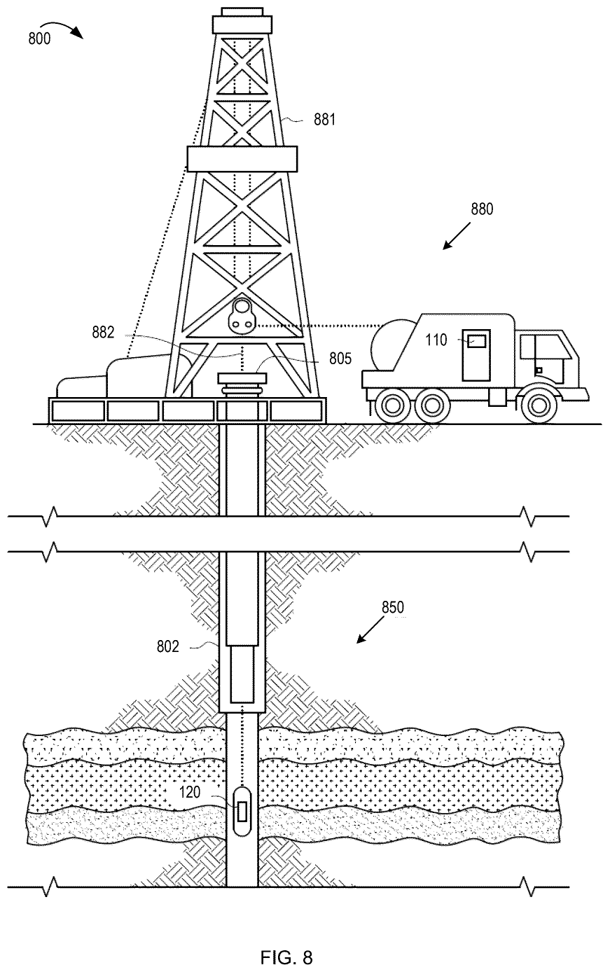

FIG. 1 depicts a schematic diagram of an example well system 100 including a nuclear magnetic resonance (NMR) tool, according to some implementations. In some implementations, the well system 100 may include a wellbore 102, surface equipment and tools, such as the computer system 110, and downhole equipment and tools, such as the NMR tool 120. The well system 100 may also include a cable 115 (e.g., a wireline) or other mechanism (such as a work string or drill string) that can lower the NMR tool 120 downhole into the wellbore 102 (or borehole). FIG. 1 shows a portion of the wellbore 102 and well system 100 for simplicity. It is noted that the well system 100 may include additional equipment, devices, tools and other components at the surface 101 or downhole that are not shown for simplicity. The well system 100 may use the NMR tool 120 for NMR logging of the subsurface formation 150 of the wellbore 102 for hydrocarbon reservoir evaluation. For example, the NMR logging may indicate various properties of the subsurface formation 150, such as the volume (e.g., porosity) and distribution (e.g., permeability) of the rock pore space, the rock composition, the type and quality of the fluids (e.g., water and hydrocarbons), and hydrocarbon producibility, among others. Therefore, the NMR measurements and other NMR data obtained from the NMR logging can be used for well site planning, well drilling, hydrocarbon recovery operations, and other well operations. Non-limiting examples of the well system 100 and the NMR tool 120 are further described in FIGS. 8-10.

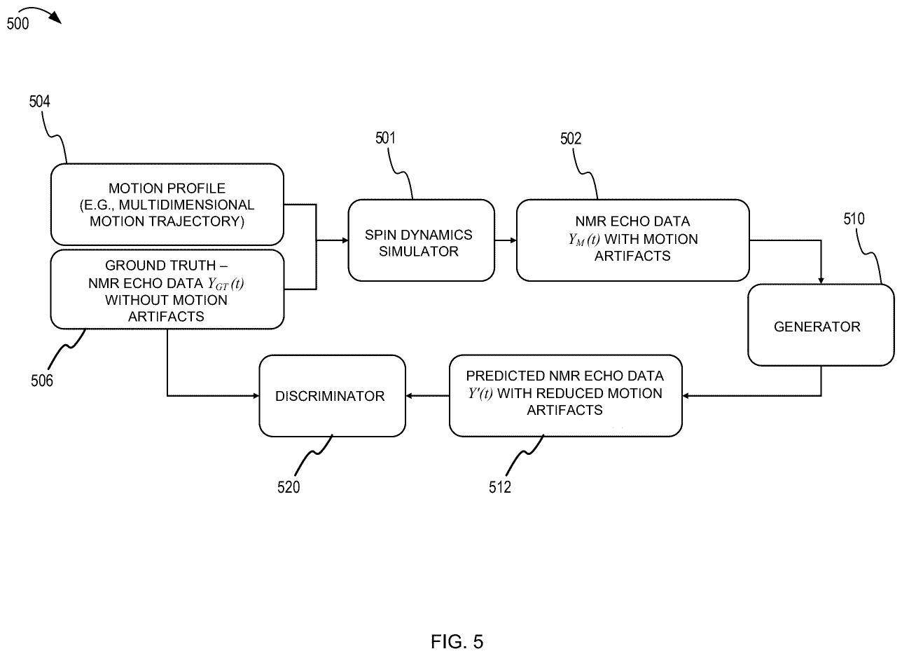

In some implementations, the well system 100 may obtain NMR echo data from the NMR tool 120. The NMR echo data may be sensitive to the motion of the NMR tool 120 and thus the NMR echo data may include motion artifacts from the downhole motion of the NMR tool 120. For example, when the NMR tool 120 is used in a logging while drilling (LWD) or a measurement while drilling (MWD) context, the longitudinal and lateral displacement due to the motion of the NMR tool 120 can distort, corrupt, or introduce motion artifacts into the NMR echo data. The motion artifacts may also be referred to as motion-based noise or motion noise. Since the motion of the NMR tool 120 can distort or corrupt the NMR echo data, the corrupted NMR echo data may lead to inaccurate results, such as the determination of inaccurate properties of the subsurface formation. For at least these reasons, the well system 100 may reduce the motion artifacts of the NMR echo data before further processing the NMR echo data to determine the subsurface formation properties. In some implementations, a machine learning system may be trained to reduce the motion artifacts of NMR echo data. For example, the well system 100 (e.g., the computer system 110) may train and test the machine learning system, and may use the trained machine learning system to reduce the motion artifacts of the NMR echo data, as further described below. The learning machine system may include a machine learning model, a deep learning model, a generative model, a neural network, and/or other suitable particularized machine(s) and/or model(s). In some implementations, the trained machine learning system may be a generative neural network (or a trained generative neural network). For example, the generative neural network may be a Variational Autoencoder (VAE) generative neural network (as shown in FIG. 4), a Generative Adversarial Network (GAN) neural network (as shown in FIG. 5). Although FIGS. 4-5 show example generative neural networks, it is noted however that the well system 100 may implement other types of generative neural networks or models, such as flow matching models or diffusion models, among others. It is also noted that in some implementations the trained neural network may be a supervised neural network (or a trained supervised neural network).

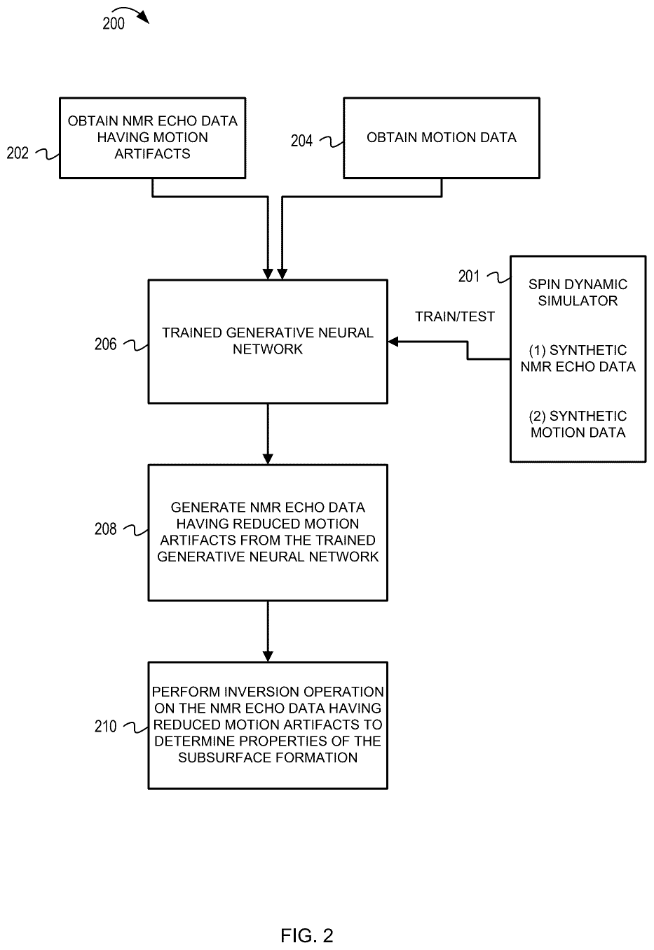

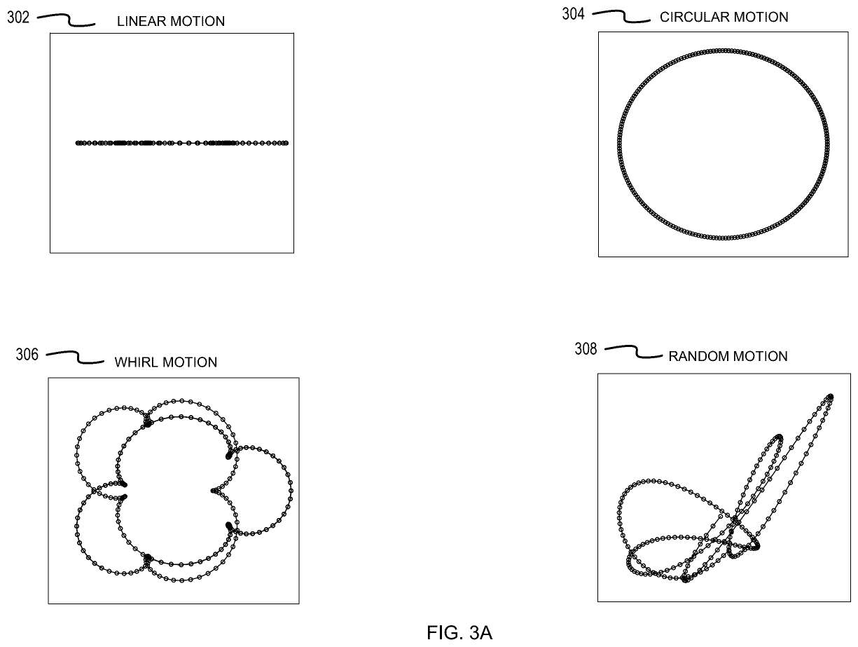

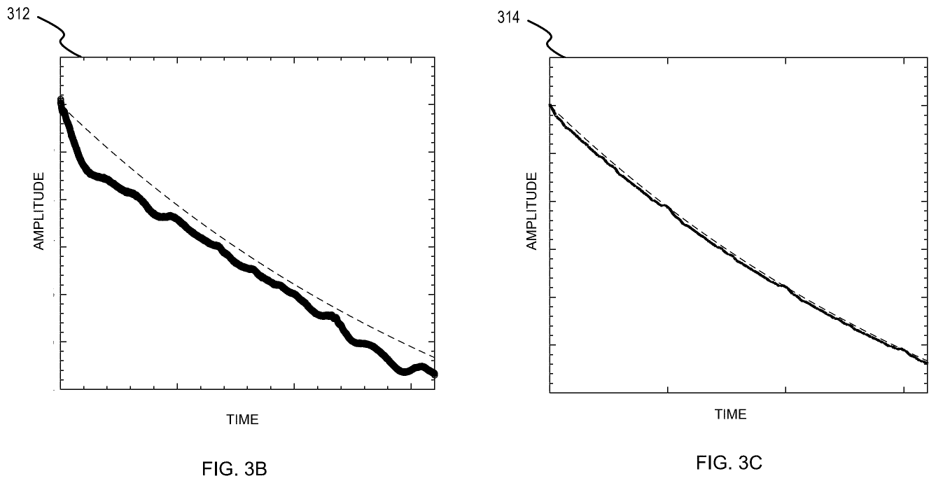

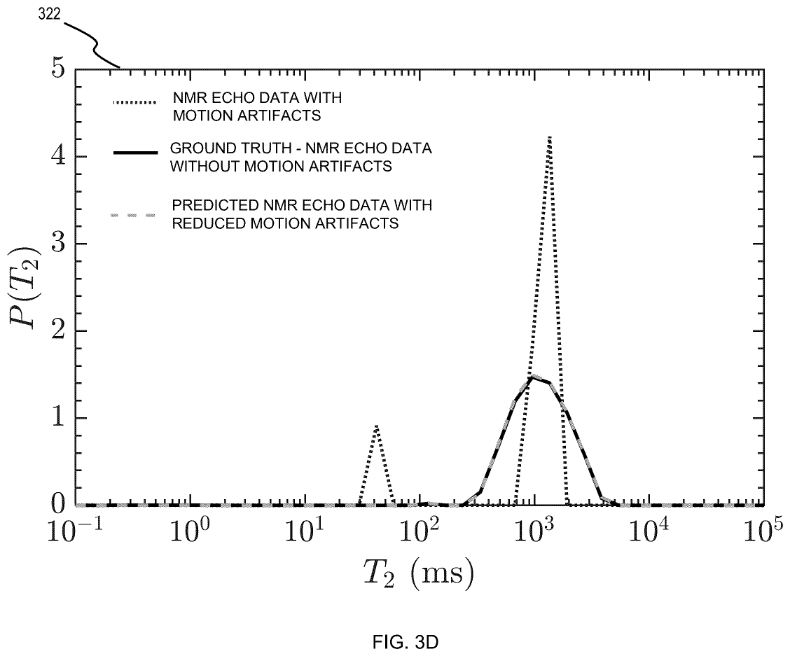

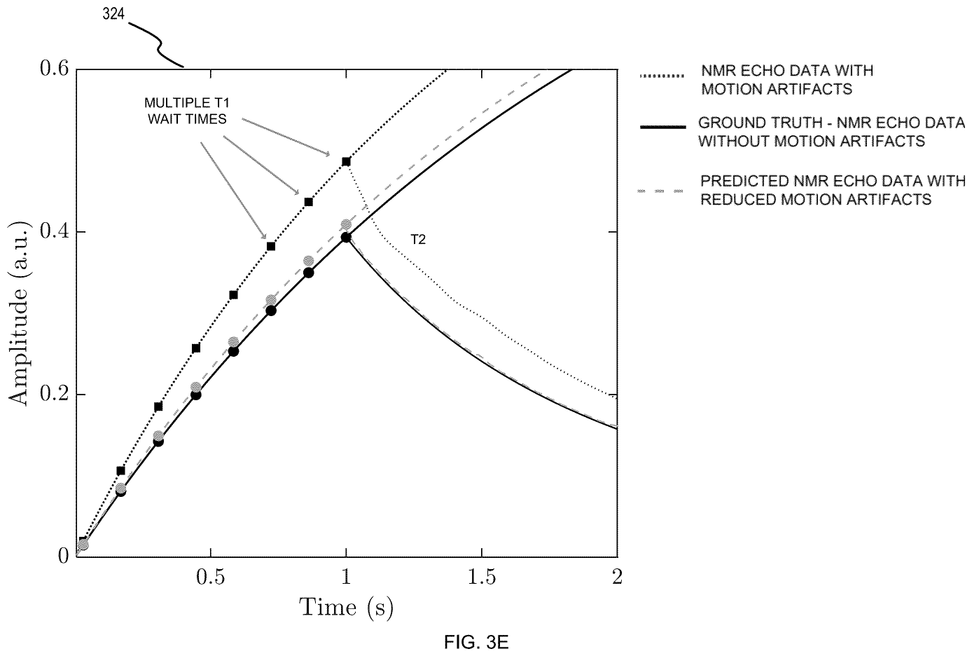

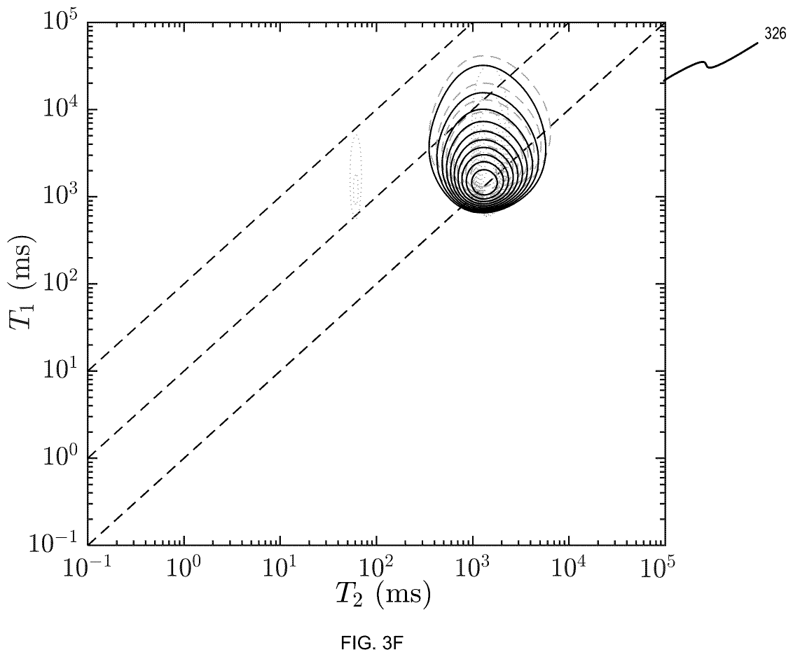

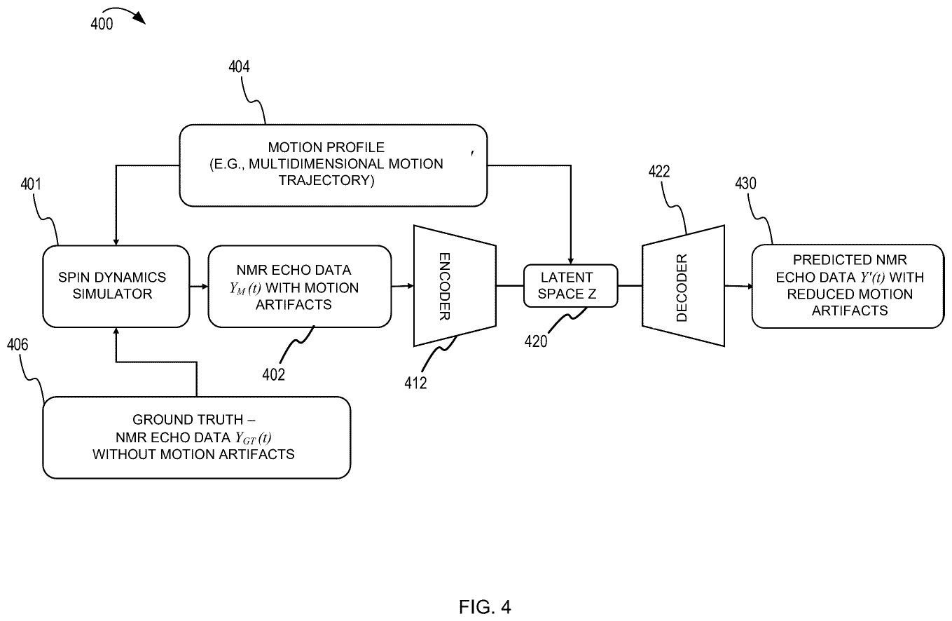

In some implementations, the machine learning system may be trained using synthetic NMR data and synthetic motion data, as shown in block 201 of FIG. 2 that depicts example operations for reducing motion artifacts from NMR echo data, according to some implementations. The machine learning system may also be tested using synthetic NMR data and synthetic motion data. In some implementations, the well system 100 may implement a spin dynamic simulator (e.g., in computer system 110) to generate the synthetic data, train, and test the machine learning system. The synthetic NMR data may include one or more of NMR echo waveforms (which may include the entire echo waveforms), magnetic field data, acquisition window data, or pulse type data. The magnetic field data may be B0, B1 magnetic field data, and the acquisition window data may indicate single acquisition window or multiple acquisition windows. The pulse type data may indicate one or more of refocusing pulses, excitation pulses, and/or nullification pulses, among others. The synthetic NMR data may also include spin-lattice relaxation time data (which may be referred to as T1 data), spin-spin relaxation time data (which may be referred to as T2 data), two dimensional T1-T2 data, diffusion-T1 data, diffusion-T2 data, or multidimensional diffusion-T1-T2 data. The synthetic motion data may include a motion displacement profile, where the motion displacement profile may include at least one of a linear motion displacement profile, a circular motion displacement profile, a whirl motion displacement profile, or a random motion displacement profile. FIG. 3A depicts example diagrams of motion displacement profiles, according to some implementations. In FIG. 3A, the example motion displacement profiles include an example linear motion displacement profile 302, an example circular motion displacement profile 304, an example whirl motion displacement profile 306, and an example random motion displacement profile 308. In some implementations, the machine learning system may be trained using both synthetic and non-synthetic NMR data and both synthetic and non-synthetic motion data. The machine learning system may also be tested using both synthetic and non-synthetic NMR data and both synthetic and non-synthetic motion data. The types of NMR data and motion data are described above. The non-synthetic NMR data and the non-synthetic motion data may be real-life or field NMR data or real-life or field motion data that are known or determined from one or more downhole well devices. For example, when the well system 100 is stationary, the field NMR data may be the ground truth or known NMR data and the field motion data may be no motion (when the NMR tool 120 is stationary), which may be detected by the NMR tool 120 and/or another downhole device (e.g., another device in the work string or wireline), such as an accelerometer or acoustic tool, among others. As another example, when the well system 100 is in motion, the field motion data may be motion data that is detected by the NMR tool 120 and/or another downhole device (e.g., another device in the work string or wireline), such as an accelerometer or acoustic tool, among others.

Deep learning in neural networks may offer significant advantages in the context of its ability to learn complex motion patterns and generate realistic NMR echo trains (or relaxation signals) with reduce motion artifacts from acquired downhole NMR echo data (having motion artifacts) and motion signals. Generative neural networks, such as a VAE generative neural network or a GAN neural network, can effectively capture the underlying structure of the motion-corrupted signal and generate relatively clean signals with high signal-to-noise ratio (SNR). In some implementations, generative neural networks can adapt and learn from the NMR echo train itself without invoking any supervised method, thereby potentially providing more accurate and robust correction even in the presence of varying motion patterns or noise levels. Additionally, generative neural networks can generalize well to unseen data, allowing for broader applicability across different motion trajectory types and acquisition protocols.

In some implementations, the well system 100 may obtain the NMR echo data with motion artifacts from the NMR tool 120, as shown in block 202 of FIG. 2. For example, the computer system 110 (or other type of surface equipment or computing device) of the well system 100 may obtain the NMR echo data with motion artifacts from the NMR tool 120. In some implementations, the obtained NMR echo data may be in the time domain. In some implementations, the NMR echo data with motion artifacts is NMR echo waveforms with motion artifacts, which may also be referred to as NMR echo waveform data with motion artifacts. In some implementations, prior to being input into the trained machine learning system, the NMR echo waveforms obtained from the NMR tool 120 can be processed to generate or obtain NMR echo trains, which also may be referred to as NMR echo train data. The NMR echo data having motion artifacts, such as the NMR echo waveforms or the NMR echo trains, may then be input into the trained machine learning system to reduce the motion artifacts, as further described below. FIG. 3B depicts an example signal diagram 312 of NMR echo data with motion artifacts, according to some implementations. As shown in FIG. 3B, one example of the NMR echo data with motion artifacts may be an NMR echo train with motion artifacts (see dark solid line). FIG. 3B also shows the ground truth for reference (see dashed line). It is noted that although the examples described herein reduce the motion artifacts (or motion-based noise) from the NMR echo data, the machine learning system can be trained and be configured to reduce other types of noise (in addition to the motion artifacts). For example, the machine learning system can reduce various types of noise (in addition to motion artifacts), such as drilling noise, electromagnetic field (EMF) noise, and/or other types of noise.

In some implementations, the well system 100 may also obtain motion data from one or more downhole devices, such as the NMR tool 120 and/or from additional downhole tools or devices, as shown in block 204 of FIG. 2. For example, the additional tools that may provide motion data may include one or more accelerometers, one or more acoustic tools, other types of tools or devices that provide an initial velocity, and/or other types of tools, devices or sensors. Some examples of motion data may include a linear motion displacement profile, a circular motion displacement profile, a whirl motion displacement profile, or a random motion displacement profile.

In some implementations, the NMR echo data with motion artifacts and the motion data may be input into the trained machine learning system to reduce the motion artifacts of the NMR echo data, as shown in block 206 of FIG. 2. For example, the NMR echo waveform data with motion artifacts or the NMR echo train data with motion artifacts, and the motion data may be input into the trained machine learning system. The trained machine learning system can receive the NMR echo data with motion artifacts and the motion data as inputs (or features) and process the inputs to generate an output (or prediction). In some implementations, the trained machine learning system may output NMR echo data with reduced motion artifacts, as shown in block 208 of FIG. 2. The trained machine learning system may process the input to cancel, remove, minimize or reduce the motion artifacts of the input to generate as an output the NMR echo data with reduced, minimized or cancelled motion artifacts. The output from the trained machine learning system may be NMR echo waveform data with reduced motion artifacts or NMR echo train data with reduced motion artifacts. FIG. 3C depicts an example signal diagram 314 of NMR echo data with reduced motion artifacts, according to some implementations. As shown in FIG. 3C, one example of the NMR echo data with motion artifacts may be an NMR echo train with reduced motion artifacts (see dark solid line). FIG. 3C also shows the same ground truth that was shown in FIG. 3B for reference (see dashed line). Compared to the NMR echo train shown in FIG. 3B that has significant motion artifacts or noise, the NMR echo train shown in FIG. 3C is a much cleaner echo train with reduced motion artifacts or noise.

In some implementations, the well system 100 may utilize the NMR measurement data, such as the NMR echo train data with reduced motion artifacts that is output from the trained machine learning system, for determining properties of the subsurface formation and performing well operations based on the properties. In some implementations, the well system 100 may perform an inversion operation on the NMR echo data (e.g., the NMR echo train data) with reduced motion artifacts to determine the properties of the subsurface formation, as shown in block 210 of FIG. 2. For example, a non-negative least square inversion algorithm Y=AX can be performed on the NMR echo data with reduced motion artifacts, or a multi-dimensional inversion operation (or other types of inversion operations) can be performed on the NMR echo data with reduced motion artifacts. After reducing the motion artifacts, the NMR echo data be used by various tools and products and services for NMR logging and well-related tasks. The well system 100 may use the NMR echo data with reduced motion artifacts and other NMR measurements for NMR logging of the subsurface formation of the wellbore for hydrocarbon reservoir evaluation. For example, the NMR logging may indicate various properties of the subsurface formation, such as the volume (e.g., porosity) and distribution (e.g., permeability) of the rock pore space, the rock composition, the type and quality of the fluids (e.g., water and hydrocarbons), and hydrocarbon producibility, among others. Therefore, the NMR measurements and other data obtained from the NMR logging can be used for well site planning, hydrocarbon recovery operations, and other well operations. In some implementations, well operations (or a well operation parameter/attribute) associated with the subsurface formation (e.g., such as drilling the well or hydrocarbon recovery) can be determined or modified based on the properties of the subsurface formation derived from the NMR measurements, such as the NMR echo data with reduced motion artifacts. For example, a drilling operation can be determined or modified, or a drilling parameter or drilling attribute can be determined or modified, based on the properties of the subsurface formation determined from the NMR echo data with reduced motion artifacts. FIG. 3D depicts an example signal diagram 322 of spectrum data after inversion, according to some implementations. As shown in FIG. 3D, the motion artifacts of the original NMR echo data have been reduced in T2 spectrum data for the predicted NMR echo data with reduced motion artifacts, and T2 spectrum data for the predicted NMR echo data with reduced motion artifacts is similar to the ground truth. FIG. 3E depicts an example signal diagram 324 of a two-dimensional signal measured across multiple wait times (WT) with corresponding Carr-Purcell-Meiboom-Gill (CPMG) measurements, including a single CPMG measurement at the longest wait time as shown, according to some implementations. As shown in FIG. 3E, one example of two-dimensional ground truth NMR relaxation data (see black solid lines), observed or simulated two-dimensional NMR relaxation data with motion artifacts on both T1 and T2 (see dark grey dot lines) and two-dimensional NMR relaxation data with reduced motion artifacts on both T1 and T2 (see light grey dash lines). FIG. 3F depicts an example signal diagram 326 of the two-dimensional signal (shown in FIG. 3E) of spectrum data after inversion, according to some implementation. As shown in FIG. 3F, the motion artifacts of the original NMR echo data have been reduced in T1-T2 spectrum data for the predicted NMR echo data with reduced motion artifacts, and T1-T2 spectrum data for the predicted NMR echo data with reduced motion artifacts is similar to the ground truth.

FIG. 4 depicts a functional block diagram of an example Variational Autoencoder (VAE) generative neural network 400, according to some implementations. As described above, in order to train the VAE generative neural network 400, in some implementations, synthetic NMR data and synthetic motion data may be input into the VAE generative neural network 400. In some implementations, both synthetic and non-synthetic NMR data and synthetic and non-synthetic motion data may be input into the VAE generative neural network 400. During the training, validating and testing process of the VAE generative neural network 400, (1) Y_{GT}(t) is the ground truth NMR echo data without motion artifacts (which may also be referred to as NMR relaxation echo train without motion artifact), (2) Y_{M}(t) is the observed motion-corrupted NMR echo data or the NMR echo data with motion artifacts (which may also be referred to as NMR relaxation echo train with motion artifacts), and (3) T(t)={x(t), y(t), z(t)} is the known motion trajectory or motion profile data that is input into the spin dynamic simulator (which causes the motion corruption or motion artifacts in Y_{M}(t)).

In some implementations, the VAE generative neural network 400 (NN_{θ}) may be trained, validated and tested such that:

$${Y}^{′} ( t ) = N {N}_{θ} ( {Y}_{M} ( t ) , T ( t ) ) , \qquad ( Equation 1.1 )$$

where Y′(t) is the predicted motion corrected output (e.g., the NMR echo data have reduced motion artifacts), ideally approximating to Y_{GT}(t). NN_{θ} is the designed neural network with multiple hyperparameters θ including but not limited to learning rate, training epochs, number of layers, and activation function etc. Then, the inversion method can be applied to Y′(t), such that:

$${Y}^{′} = {AX}^{′} + ϵ , \qquad ( Equation 1.2 )$$

where A is the kernel or basis function, X′ is the predicted T1/T2 spectrum, and e is the noise term.

As shown in the example of FIG. 4, the spin dynamics simulator 401 may generate synthetic NMR data, such as synthetic NMR echo data Y_{M}(t) with motion artifacts 402 (which also may be referred to as synthetic NMR relaxation echo data Y_{M}(t) with motion artifacts). In some implementations, the spin dynamics simulator 401 may generate the synthetic NMR echo data Y_{M}(t) with motion artifacts 402 based on synthetic motion profile data 404, such as multidimensional motion trajectory T(t)={x(t), y(t), z(t)}, and the ground truth NMR echo data Y_{GT}(t) without motion artifacts 406 (which may be referred to as the ground truth NMR relaxation echo data Y_{GT}(t) without motion artifacts). Additional types of synthetic NMR data may also be input, such as magnetic field data, acquisition window data, and/or pulse type data, among others. In some implementations, the synthetic NMR echo data Y_{M}(t) with motion artifacts 402 may be provided to an encoder 412. In some implementations, the encoder 412 may implement multilayer perceptron, which is a feedforward neural network design with multiple layers that compresses input data into lower dimensional representation, such as for dimensional reduction or feature extraction. Other implementations may be other architectures such as convolutional neural networks or recurrent neural networks, etc. The encoder 412's likelihood function q_{φ}(Z|T(t), Y_{M}(t)) may map the motion trajectory T(t) and the NMR echo data Y_{M}(t) to a latent space 420 representation Z. The decoder 422 may map the latent space 420 variable back to the original, higher dimensional data space and reconstruct the input with reduced motion artifacts. For example, the decoder 422's approximation posterior p_{θ}(Y′(t)|Z, T(t)) may output the predicted NMR echo data Y′(t) with reduced motion artifacts given the latent space 420 representation Z and motion trajectory T(t). Therefore, the output of the decoder 422 (and the output of the VAE generative neural network 400) may be the predicted NMR echo data Y′(t) with reduced motion artifacts 430 (which may be referred as the predicted NMR relaxation echo data Y′(t) with reduced motion artifacts). In some implementations, the decoder 422 may be multilayer perceptron, convolutional neural networks or recurrent neural networks, etc.

Furthermore, in FIG. 4, regarding loss of function during the training of the learning machine network, reconstruction loss Lᵣₑₛ ensures the predicted output Y′(t) close to ground truth Y_{GT} (t), as follows:

$${L}_{r e s} = {E}_{{q}_{ϕ} ( Z \vert T ( C ) , {Y}_{M} ( t ) )} {‖ {Y}_{G T} ( t ) - {Y}^{′} ( t ) ‖}_{2}^{2} , \qquad ( Equation 2.1 )$$

where E_{q}_{_{φ}}_{(Z|T(t), Y}_{_{M}}₍ₜ₎₎ is the expectation that represents the reconstruction accuracy, averaging over all possible values of latent space Z. In some implementations, the reconstruction loss may be measured by mean square error (MSE) between the ground truth relaxation data Y_{GT}(t) and the predicted relaxation data Y′(t).

Kullback-Leibler (KL) divergence loss L_{KL} (or other divergence loss functions like Jensen-Shannon (JS) divergence, etc.) regularizes the latent space to follow a certain type of distribution p(Z), as shown below:

$${L}_{K L} = {D}_{K L} ( {q}_{ϕ} ( Z \vert T ( t ) , {Y}_{M} ( t ) ) \vert \vert p ( Z ) ) , \qquad ( Equation 2.2 )$$

where D_{KL}(q_{φ}(Z|T(t), Y_{M}(t))∥p(Z)) is the KL divergence to ensure that q_{φ}(Z|T(t), Y_{M}(t)) remains close to the prior p(Z). The representations of latent space distributions are further described below.

The total loss can be represented as follows:

$${L}_{total} = {L}_{r e s} + α {L}_{K L} , \qquad ( Equation 2.3 )$$

where α controls the regularization strength.

The latent space representation p(Z) (shown in Equation 2.2) can have different distributions depending on the motion profile data (or the motion trajectory). If the motion profile (or motion trajectory) is a simple linear motion, the latest space can follow a normal distribution, shown below:

$${p}_{linear} ( Z ) ∼ N ( μ , {σ}^{2} ) , \qquad ( Equation 3.1 )$$

where μ is the mean value and σ² is the variance, determine the distribution of latent space.

If the motion profile is a sinusoidal T(t){x(t), y(t), z(t)}=Acos(wt+φ) or with high-order harmonic motion

$$T ( t ) \{ x ( t ) , y ( t ) , z ( t ) \} = {\sum }_{n = 1}^{N} {A}_{n} ( n ω t + {ϕ}_{n} ) ,$$

where Aₙ and φₙ are amplitude and phase for nth harmonic motion and no is the nth frequency, then the latent space representation can also capture this periodic feature and can be a mixture of periodic functions to ensure the latent variable aligns with periodic motion, as follows:

$${p}_{harmonic} ( Z ) ∼ N ( {μ}_{n} , {σ}_{n}^{2} ) cos ( n ω t + {ϕ}_{n} ) , \qquad ( Equation 3.2 )$$

where N(μₙ, σₙ) is the normal distribution with mean value μₙ and variance

$${σ}_{n}^{2}$$

for the nth mode.

If the motion profile is a complex random motion, instead of a fixed Gaussian prior or harmonic-like prior, there are a few other priors that can be used for the latent space representation of complex random motion, such as a Gaussian mixture model (GMM) prior, a nonparametric Gaussian Process (GP) prior, or a flow-based learned prior etc. The GMM prior can be represented as follows:

$${p}_{GMM} ( Z ) ∼ {\sum }_{k = 1}^{K} {π}_{k} N ( {u}_{k} , {σ}_{k}^{2} ) , \qquad ( Equation 3.3 )$$

where k is the number of mixture components and πₖ are the mixture weights of the kth normal distribution

$$N ( {u}_{k} , {σ}_{k}^{2} )$$

with mean value μₖ and variance

$${σ}_{k}^{2} .$$

The GP prior can be represented as follows:

$${p}_{GP} ( Z ) ∼ GP ( m ( T ) , k ( T , {T}^{′} ) ) , \qquad ( Equation 3.4 )$$

where m(T) is the mean function and k(T, T′) is the covariance kernel function that controls how correlated latent variables over time t. In some implementations, the kernel k(T, T′) may be radial basis function etc.

FIG. 5 depicts a functional block diagram of an example Generative Adversarial Network (GAN) neural network 500, according to some implementations. As described above, in order to train the GAN neural network 500, in some implementations, synthetic NMR data and synthetic motion data may be input into the GAN neural network 500. In some implementations, both synthetic and non-synthetic NMR data and synthetic and non-synthetic motion data may be input into the GAN neural network 500. During the training, validating and testing process of the GAN generative neural network 500, (1) Y_{GT} (t) is the ground truth NMR echo data without motion artifacts (which may also be referred to as NMR relaxation echo train without motion artifact), (2) Y_{M} (t) is the observed motion-corrupted NMR echo data or the NMR echo data with motion artifacts (which may also be referred to as NMR relaxation echo train with motion artifacts), and (3) T(t)={x(t), y(t), z(t)} is the known motion trajectory or motion profile data that is input into the spin dynamic simulator (which causes the motion corruption or motion artifacts in Y_{M}(t)).

In some implementations, the GAN generative neural network 500 (NN_{θ}) may be trained, validated and tested as shown in Equation 1.1 above, where Y′(t) is the predicted motion corrected output (e.g., the NMR echo data have reduced motion artifacts), ideally approximating to Y_{GT}(t). Then, the inversion method can be applied to Y′(t), as shown in Equation 1.2 above, where A is the kernel or basis function, X′ is the predicted T1/T2 spectrum, and e is the noise term.

As shown in the example of FIG. 5, the spin dynamics simulator 501 may generate synthetic NMR data, such as synthetic NMR echo data Y_{M}(t) with motion artifacts 502 (which also may be referred to as synthetic NMR relaxation echo data with motion artifacts). In some implementations, the spin dynamics simulator 501 may generate the synthetic NMR echo data Y_{M}(t) with motion artifacts 502 based on synthetic motion profile data 504, such as multidimensional motion trajectory T(t)={x(t), y(t), z(t)}, and the ground truth NMR echo data Y_{GT}(t) without motion artifacts 506 (which may be referred to as the ground truth NMR relaxation echo data Y_{GT}(t) without motion artifacts). Additional types of synthetic NMR data may also be input, such as magnetic field data, acquisition window data, and/or pulse type data, among others. In some implementations, the synthetic NMR echo data Y_{M}(t) with motion artifacts 502 may be provided to a generator 510. The generator 510 (G_{θ}(Y_{M}(t), T(t))) generates and outputs predicted NMR echo data Y′(t) with reduced (or corrected) motion artifacts 512 (which may be referred as the predicted NMR relaxation echo data with reduced or corrected motion artifacts). In some implementations, the generator 510 may be multilayer perceptron, convolutional neural networks, residual convolutional neural networks or attention-based transformer architecture, etc. The NMR echo data Y′(t) with reduced motion artifacts 512 may be provided as inputs to a discriminator 520 (D_{φ}(Y_{GT}(t))). In some implementations, the discriminator 520 implements multilayer perceptron, convolutional neural networks, residual convolutional neural networks or attention-based transformer architecture etc. The discriminator 520 distinguishes between the ground truth Y_{GT}(t) and the generated corrected echo data Y′(t).

In some implementations, the loss function when training the machine learning system may include the discriminator 520 trying to distinguish the corrected echo data Y′(t) from the ground truth Y_{GT}(t), as follows:

$${L}_{D} = - {E}_{{Y}_{GT} ( t )} [ log {D}_{ϕ} ( {Y}_{GT} ( t ) ) ] - {E}_{{Y}^{′} ( t )} [ log ( 1 - {D}_{ϕ} ( {Y}^{′} ( t ) ) ) ] , \qquad ( Equation 4.1 )$$

where E_{Y}_{_{GT}}₍ₜ₎ [logD_{φ}(Y_{GT}(t))] ensures the discriminator to output a probability close to 1 for the real ground truth signal Y_{GT}(t) and E_{Y′(t)} [log(1−D^{φ}(Y′(t)))] ensures the discriminator to output a probability close to 0 for the fake generated signal Y′(t)=G^{θ}(Y_{M}(t), T(t)).

In some implementations, the generator 510 tries to test the discriminator 520 by making Y′(t) as close to ground truth as possible, as follows:

$${L}_{G} = - {E}_{{Y}^{′} ( t )} [ log {D}_{ϕ} ( {Y}^{′} ( t ) ) ] . \qquad ( Equation 4.2 )$$

The generator loss encourages the generator to maximize the probability that the discriminator classify the generated signal as real.

The reconstruction loss may be represented as follows:

$${L}_{res} = {‖ {Y}_{GT} ( t ) - {Y}^{′} ( t ) ‖}_{2}^{2} . \qquad ( Equation 4.3 )$$

In some implementations, the reconstruction loss may be measured by mean square error (MSE) between the ground truth relaxation data Y_{GT}(t) and the predicted relaxation data Y′(t).

The motion consistency loss Lₘₒₜᵢₒₙ may ensure the correction removes the motion artifacts while remaining consistent with inputted prior motion profile T(t). Based on the above, the total loss may be represented as follows:

$${L}_{total} = {λ}_{1} {L}_{G} + {λ}_{2} {L}_{res} + {λ}_{3} {L}_{motion} , \qquad ( Equation 4.4 )$$

where λ₁, λ₂ and λ₃ are the hyperparameters that control the regularization. The Lₘₒₜᵢₒₙ is further described below.

In some implementations, a possible motion consistency loss Lₘₒₜᵢₒₙ may be defined to reduce the motion artifacts while utilizing the motion prior knowledge, as described below. For linear or harmonic motion profiles, e.g., T(t){x(t), y(t), z(t)}=Acos(ωt+φ), the motion derivative loss may be designed by the first derivative or second derivative structure of the corrected echo Y′(t) to match that of the known motion profile T(t) from known synthetic motion, velocity or of the accelerometer data.

$${L}_{motion} = {‖ \frac{{dY}^{′} ( t )}{dt} - \frac{dT ( t )}{dt} ‖}_{2}^{2} , \qquad ( Equation 4.5 )$$

$${L}_{motion} = {‖ \frac{d}{dt} ( \frac{{dY}^{′} ( t )}{dt} ) - \frac{d}{dt} ( \frac{dT ( t )}{dt} ) ‖}_{2}^{2} . \qquad ( Equation 4.6 )$$

Instead of designing the motion loss in the time domain, the consistency loss between the corrected echo Y′(t) and the expected frequency components in the frequency domain may be designed as follows:

$${L}_{motion} = {\sum }_{ω} {‖ {ℱ ( {Y}^{′} ( t ) )}_{ω} - {ℱ ( T ( t ) )}_{ω} ‖}_{2}^{2} , \qquad ( Equation 4.7 )$$

where [symbol] (Y′(t))_{ω} is the Fast Fourier transform on the predicted echo data Y′(t) and [symbol] (T(t))_{ω} is the Fast Fourier transform on the motion profile T(t).

For random complex motion, enforcing a Gaussian or harmonic prior may not be sufficient. Instead, the probability distributions of ground truth Y_{GT}(t) and motion-corrected signals Y′(t) may be matched using Wasserstein distance. For example, a conditioned Wasserstein distance loss can be defined as follows:

$${L}_{motion} = W ( {P}_{{Y}_{GT} ( t ) \vert T ( t )} , {P}_{{Y}^{′} ( t ) \vert T ( t )} ) , \qquad ( Equation 4.8 )$$

where P_{Y}_{_{GT}}_{(t)|T(t)} is the probability distribution of the ground truth signal Y_{GT}(t) given motion profile T(t), and P_{Y′(t)|T(t)} is the probability distribution of the predicted corrected signal Y′(t) given motion profile T(t).

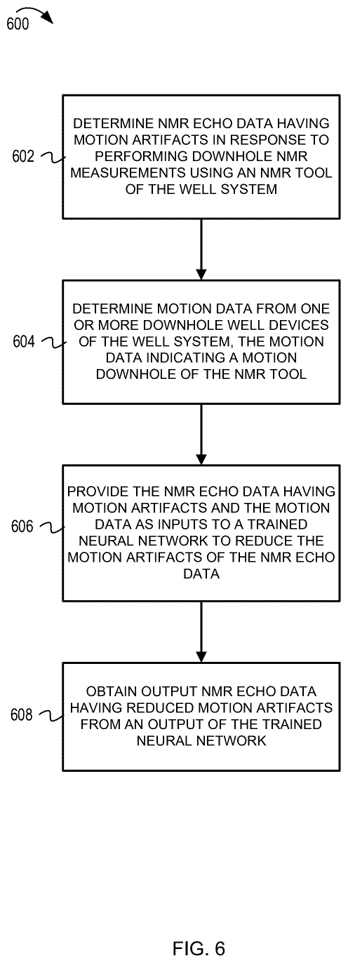

FIG. 6 is a flowchart 600 of example operations for obtaining nuclear magnetic resonance (NMR) measurements of a subsurface formation in a well system, according to some implementations. In some implementations, NMR echo data having motion artifacts may be determined in response to performing downhole NMR measurements using an NMR tool of the well system (block 602). In some implementations, motion data may be determined from one or more downhole well devices of the well system. The motion data may indicate a motion downhole of the NMR tool (block 604). In some implementations, the NMR echo data having motion artifacts and the motion data may be provided as inputs to a trained machine learning system to reduce the motion artifacts of the NMR echo data (block 606). In some implementations, output NMR echo data having reduced motion artifacts is obtained from an output of the trained machine learning system (block 608).

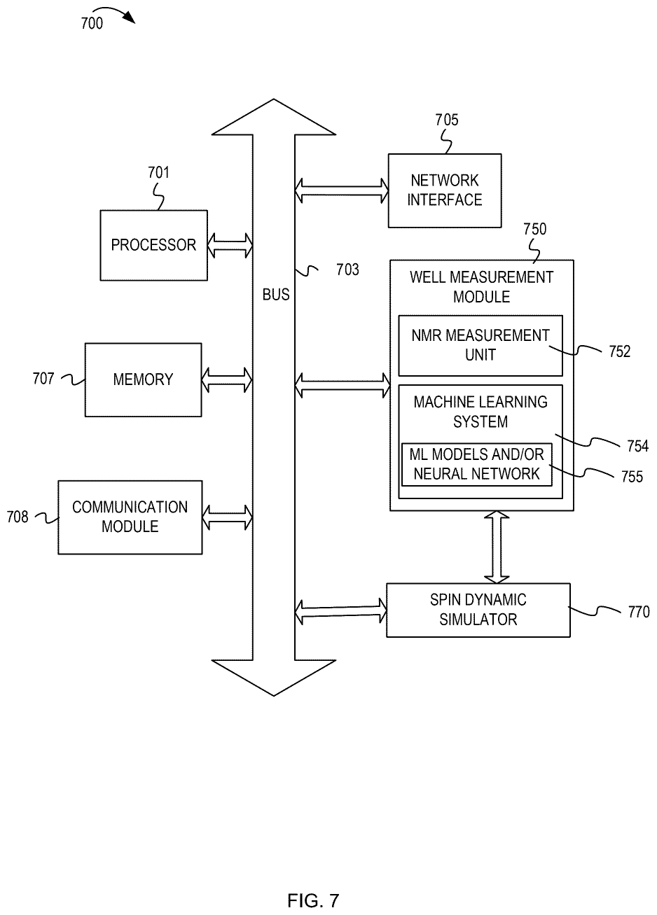

FIG. 7 depicts an example computer system of a well system for performing NMR measurements of a subsurface formation, according to some implementations. In some implementations, the computer system 700 may be an example of a computer system that may be used during the operation of the well system, such as the computer system 110 shown in FIG. 1. For example, the computer system 700 may be a standalone computer system (such as a workstation, laptop, or desktop), or may be partially or fully integrated into other surface equipment of the well system (e.g., control panel or truck). In some implementations, the computer system 700 may be implemented partially or fully in downhole components of the well system (e.g., within the NMR tool and/or work string and/or well tubing) or the computing functions of the computer system 700 may be distributed across both downhole components (e.g., NMR tool and/or work string) and surface equipment (e.g., workstation or other computer subsystem). The computer system 700 may include one or more processors 701 (possibly including multiple cores, multiple nodes, and/or implementing multi-threading, etc.). The computer system 700 may include memory 707. The memory 707 may be system memory or any type or implementation of machine or computer readable media having instructions that are executable by the one or more processors 701 to implement the operations described in FIGS. 1-6. The memory 707 may be system memory or any type or implementation of machine or computer readable and writable media having the ability to receive, process and/or store measurement data from well devices and tools (including those described in FIGS. 1-6). The computer system 700 also may include a bus 703 and a network interface 705. The computer system 700 also may include a communications module 708 that may control wired and wireless communications, such as communicating with downhole devices or tools and communicating with other surface equipment. The computer system 700 also may include at least a well measurement module 750 and a spin dynamic simulator 770, among other processing units or modules that are used during the operation of the well system and the well tools described herein (not shown for simplicity). The well measurement module 750 may include an NMR measurement unit 752 and a machine learning system 754. In some implementations, the NMR measurement unit 752 may control above ground and downhole equipment and tools to obtain measurement data, such as controlling an NMR tool that can take NMR measurements downhole of a subsurface formation for NMR logging, as described in FIGS. 1-6. The NMR measurement unit 752 may also cause the NMR tool to generate NMR pulses and may receive, process and analyze NMR measurements, such as NMR echo data. In some implementations, the machine learning system 754 (which may also be referred to as a learning machine), such as the machine learning system described above in FIGS. 1-6, may include computer code and/or a neural network and/or ML models 755 (such as machine learning model(s), deep learning model(s), and/or generative model(s), among others) and be implemented on a non-transitory computer readable medium, circuitry, and/or any other logic components configured to perform the operations described above in FIGS. 1-6. The machine learning system 754 may be trained to perform the operations described above in FIGS. 1-6, including inputting NMR echo data and motion data, reducing motion artifacts in NMR echo data, and outputting NMR echo data with reduced motion artifacts. The spin dynamic simulator 770 may generate synthetic NMR data and synthetic motion data to train and test the machine learning system 754 to implement the operations described above in FIGS. 1-6. In some implementations, the well measurement module 750 may work in conjunction with the spin dynamic simulator 770 to train and test the machine learning system 754. In some implementations, the NMR measurement unit 752 (in conjunction with other control and processing units of the computer system 700) may utilize the NMR measurement data (e.g., NMR echo data) for determining properties of the subsurface formation and performing and/or modifying well operations (or well parameters/attributes) based on the determined properties of the subsurface formation, as described above. It is noted that FIG. 7 shows a non-limiting example of the computer system 700, and the computer system 700 and/or its components may be implemented in various ways. For example, the machine learning system 754 may be implemented in a separate module as the well measurement module 750, or the well measurement module 750 and/or the machine learning system 754 may be implemented in two separate computing systems. The functionality described herein may be implemented with an application-specific integrated circuit, in logic implemented in the processor(s) 701, in a co-processor on a peripheral device or card, etc. Further, implementations may include fewer or additional components not illustrated in FIG. 7. The processor(s) 701 and the network interface 705 may be coupled to the bus 703. Although illustrated as being coupled to the bus 703, the memory 707 may be coupled to the processor(s) 701.

NMR logging is possible because when an assembly of magnetic moments, such as those of hydrogen nuclei spins, are exposed to a static magnetic field they tend to align along the direction of the magnetic field, resulting in bulk magnetization. The rate at which equilibrium is established in such bulk magnetization upon provision of a static magnetic field is characterized by the parameter T1, referred to as the spin-lattice relaxation time. Another related NMR logging parameter is T2, referred to as the spin-spin relaxation time constant (also referred to as the transverse relaxation time), which is an expression of the relaxation due to nuclear spins dephasing. NMR logging has two main experiments in oil field downhole usage. The first experiment is to assess T1 buildup of magnetization, and the second experiment is to observe the decay of magnetization once it has been excited, in which the decay has a time constant of T2.

Measurement of T1 is indirect and is done by varying the polarization times after magnetization has, through some means, been nullified or inverted. For downhole observation, an NMR measurement technique, designed by Carr, Purcell, Meiboom, and Gill and, hence, referred to as CPMG, is used. It is considered a T2 measurement. As described previously, CPMG has an excitation pulse followed by several refocusing pulses to counter the magnetic gradients in downhole NMR systems. A T1 sequence is typically performed as: Nullification Pulse—WaitTime—Excitation Pulse—Refocusing pulses. In some cases, the T1 sequence has several different wait times. The number of refocusing pulses may be as few as 3 and as many as associated electronics are configured to handle (e.g., acquire and/or process).

A portion of the hydrogen nuclei spins in the earth formation are, in the aggregate, caused to be aligned with the magnetic field induced in the earth formation by a magnet and result in a net magnetization of the formation. The NMR tool (e.g., such as the NMR tool 120 in FIG. 1) also includes an antenna positioned near the magnet and shaped so that a pulse of RF power conducted through the antenna induces a magnetic field in the earth formation orthogonal to the field induced by the magnet. A receiving antenna (which may be the same antenna as the one that generates the initial RF pulse) is electrically connected to a receiver, which detects and measures voltages induced in the receiving antenna by precessional motion of the nuclear spins.

A NMR measurement involves a plurality of pulses grouped into pulse sequences, most frequently of a type known as CMPG pulsed spin echo sequences. Each CPMG sequence consists of an excitation pulse, which may be a 90-degree (i.e., π/2) pulse, followed by several refocusing pulses, which may be 180-degree (i.e., π) rotation pulses. The excitation pulse rotates the proton spins into the transverse plane and the refocusing pulses generate a sequence of spin echoes by refocusing the transverse magnetization after each spin echo.

NMR well logging data are sensitive to motion of the NMR tool. In an example in which the NMR tool is used in a logging while drilling (LWD) or a measurement while drilling (MWD) context, a lateral motion (e.g., vibration) and rotational movement of drilling operations may cause distortion of the NMR well logging data and, in some cases, an inability to acquire a spin echo signal representing transversal NMR relaxation (i.e., T2 relaxation).

While rotational sensitivity may be reduced by designing the NMR tool to be essentially axially symmetrical, the longitudinal and lateral displacement due to NMR tool motion (e.g., vibration), such as while drilling, remains problematic for NMR data acquisition in a LWD or MWD context.

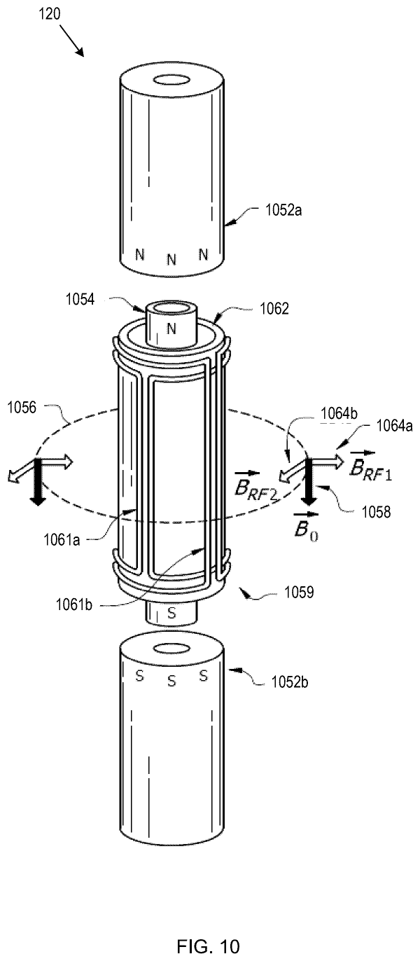

In some implementations, the NMR logging operations can be performed in connection with various types of downhole operations at various stages in the lifetime of a well system. Structural attributes and components of the surface equipment and NMR tool can be adapted for various types of NMR logging operations. For example, NMR logging may be performed during wireline logging operations (e.g., see FIG. 10), during drilling operations (e.g., see FIG. 11), or in other contexts. Accordingly, the surface equipment and the NMR tool may include, or may operate in connection with drilling equipment, wireline logging equipment, or other equipment for other types of operations. As another example, NMR logging may be performed in an offshore or subsea environment. Accordingly, the surface equipment may be arranged on a drill ship or other offshore drilling vessel, and the NMR tool operates in connection with offshore drilling equipment, offshore wireline logging equipment, or other equipment for use with offshore operations.

FIG. 8 shows an example well system 800 that includes the NMR tool 120 in a wireline logging environment, according to some implementations. The NMR tool 120 may be an example of the NMR tool 120 shown in FIG. 1. In some example wireline logging operations, the surface equipment 880 may include a platform above the surface equipped with a derrick 881 that supports a wireline cable 882 that extends into the wellbore 802 through the wellhead 805. Wireline logging operations can be performed, for example, after a drill string is removed from the wellbore 802, to allow the NMR tool 120 to be lowered by wireline or logging cable into the wellbore 802.

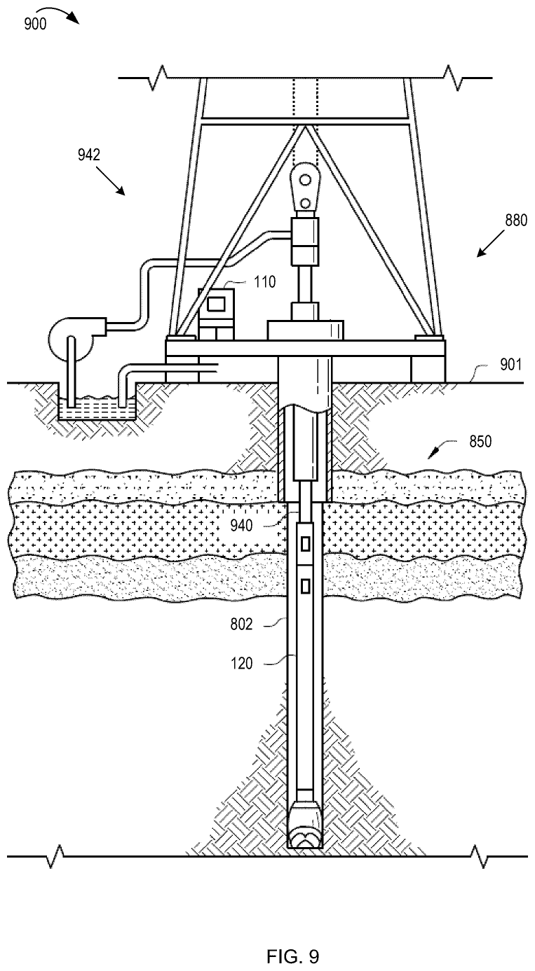

FIG. 9 shows an example well system 900 that includes the NMR tool 120 in a drilling environment, according to some implementations. For example, the drilling environment may include performing logging while drilling (LWD) operations or a measurement while drilling (MWD) operations. The NMR tool 120 may be an example of the NMR tool 120 shown in FIG. 1. Drilling is commonly carried out using a string of drill pipes connected together to form a drill string 940 that is lowered through a rotary table into the wellbore 802. In some cases, a drilling rig 942 at the surface 901 supports the drill string 940, as the drill string 940 is operated to drill a wellbore penetrating the subsurface formation 850. The drill string 940 may include, for example, a kelly, drill pipe, a bottomhole assembly, and other components. The bottomhole assembly on the drill string may include drill collars, drill bits, the NMR tool 120, and other components, including additional logging tools. The additional logging tools may include MWD tools, LWD tools, and others.

In some implementations, the NMR tool 120 is configured to obtain NMR measurements from the subsurface formation 850. As shown, for example, in FIG. 8, the NMR tool 120 can be suspended in the wellbore 802 by a coiled tubing, wireline cable, or another structure that connects the tool to a surface control unit or other components of the surface equipment 880. In some example implementations, the NMR tool 120 is lowered to the bottom of a region of interest and subsequently pulled upward (e.g., at a substantially constant speed) through the region of interest. As shown, for example, in FIG. 9, the NMR tool 120 can be deployed in the wellbore 802 on jointed drill pipe, hard wired drill pipe, or other deployment hardware. In some example implementations, the NMR tool 120 collects data (e.g., measurement data) during drilling operations as it moves downward through the region of interest. In some example implementations, the NMR tool 120 collects data while the drill string 940 is moving, for example, while it is being tripped in or tripped out of the wellbore 802.

In some implementations, the NMR tool 120 collects data at discrete logging points in the wellbore 802. For example, the NMR tool 120 can move upward or downward incrementally to each logging point at a series of depths in the wellbore 802. At each logging point, instruments in the NMR tool 120 perform measurements on the subsurface formations 850. The measurement data can be communicated to the computer system 110 for storage, processing, and analysis. Such data may be gathered and analyzed during drilling operations (e.g., during LWD/MWD operations), during wireline logging operations, or during other types of activities. The computer system 110 shown in FIGS. 8 and 9 may be configured to receive and analyze the measurement data from the NMR tool 120 to detect properties of the subsurface formation 850, as previously described above in FIG. 1.

In some implementations, the NMR tool 120 obtains NMR signals by polarizing nuclear spins in the subsurface formation 850 and pulsing the nuclei with a radio frequency (RF) magnetic field. Various pulse sequences (i.e., series of radio frequency pulses, delays, and other operations) can be used to obtain NMR signals, including the CPMG sequence (in which the spins are first tipped using an excitation (or tipping) pulse followed by a series of refocusing pulses), the Optimized Refocusing Pulse Sequence (ORPS) (in which the refocusing pulses are less than 180°), a saturation recovery pulse sequence, and other pulse sequences. The NMR tool 120 collects measurements relating to spin relaxation time (e.g., T1, T2) distributions as a function of depth or position in the borehole. The NMR tool 120 has a magnet, antenna, and supporting electronics. The permanent magnet in the tool causes the nuclear spins to build up into a cohesive magnetization. The T2 is measured through the decay of excited magnetization while T1 is measured by the buildup of magnetization.

The computer system 110 is configured to process (e.g., invert, transform, etc.) the acquired spin echo signals (or other NMR data) to obtain an NMR signal, such as a relaxation-time distribution (e.g., a distribution of transverse relaxation times T2, or a distribution of longitudinal relaxation times T1, or both). For example, the acquired spin echo signals are integrated using acquisition windows having different durations to generate the different NMR echo train signals. The relaxation-time distribution can be used to determine various physical properties of the formation by solving one or more inverse problems. In some cases, relaxation-time distributions are acquired for multiple logging points and used by the computer system 110 to train a model of the subsurface formation 850. In some cases, relaxation-time distributions are acquired for multiple logging points and used by the computer system 110 to predict properties of the subsurface formation 850. The relaxation data may also be referred to as NMR echo train data.

FIG. 10 is a diagram of an example NMR magnet and antenna(s) configuration of an NMR tool 120, according to some implementations. The example NMR tool 120 includes a magnet assembly that generates a static magnetic field to produce polarization, and an antenna assembly that generates a radio frequency (RF) magnetic field to excite nuclei and acquires NMR signals from the surrounding formation. In the non-limiting example shown in FIG. 10, the magnet assembly that includes the end piece magnets 1052a, 1052b and a central magnet 1054 generates the static magnetic field in the volume of investigation 1056. The poles of the central magnet 1054 (e.g., north (N) and south(S)) face the like poles of the proximal end piece magnets 1052a, 1052b. The central magnet 1054 is useful to shape and strengthen the static magnetic field in the volume of investigation 1056. In this example, the volume of investigation 1056 is approximately a cylindrical shell. In the volume of investigation 1056, the direction of the static magnetic field (shown as the solid black arrow 1058) is parallel to the longitudinal axis of the wellbore. In some examples, a magnet configuration with a bigger central magnet can be used to create a double pole strength and therefore increase the strength of the magnetic field (e.g., up to 100-150 Gauss or higher in some instances).

In the non-limiting example shown in FIG. 10, the antenna assembly 1059 includes two mutually orthogonal transversal dipole antennas 1061a, 1061b. In some instances, the NMR tool 120 can be implemented with a single transversal-dipole antenna. For example, one of the orthogonal transversal-dipole antennas 1061a, 1061b may be omitted from the antenna assembly 1059. The example orthogonal transversal-dipole antenna 1061a, 1061b shown in FIG. 10 are placed on an outer surface of a soft magnetic core 1062, which is useful for RF magnetic flux concentration. The antenna assembly 1059 generates two orthogonal RF magnetic fields 1064a (e.g., produced by the antenna 1061a) and 1064b (e.g., produced by the antenna 1061b). The two RF magnetic fields 1064a, 1064b have a phase shift of 90°. Accordingly, the RF magnetic fields 1064a, 1064b generate a circular polarized RF magnetic field to excite NMR in the surrounding formation more efficiently. It is also possible to only transmit with one antenna, even if a second antenna is included in the assembly. For example, the second antenna could be used only to receive NMR signals in this configuration. The same two orthogonal transversal-dipole antennas 1061a, 1061b are used to receive NMR signals from the surrounding formation. The received NMR signals are from induced currents from the NMR magnetization. The signals in the orthogonal transversal-dipole antennas 1061a, 1061b, may then be processed (e.g., by the computer system 110 of FIGS. 1 and 9-11) together in order to increase a signal-to-noise ratio (SNR) of the acquired NMR data.

In some implementations, the antenna assembly 1059 additionally or alternatively includes an integrated coil set that performs the operations of the two orthogonal transversal-dipole antennas 1061a, 1061b. For example, the integrated coil may be useful (e.g., instead of the two orthogonal transversal-dipole antennas 1061a, 1061b) to produce circular polarization and perform quadrature coil detection. Examples of integrated coil sets that can be adapted to perform such operations include multi-coil or complex single-coil arrangements, such as, for example, birdcage coils used for high-field magnetic resonance imaging (MRI). It is noted that the specific geometry and/or configuration of the NMR tool 120 is not necessarily limited to that shown in FIG. 10, and in other implementations, the NMR tool 120 may have different geometry and/or configurations.

Although some example well systems are described in FIGS. 1-10, it is noted, however, that the techniques and operations for performing NMR measurements and reducing motion artifacts from the NMR measurements described in FIGS. 1-10 can be used in any type of well system in the oil and gas industry.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

None of the implementations described herein may be performed exclusively in the human mind nor exclusively using pencil and paper. None of the implementations described herein may be performed without computerized components such as those described herein. Some implementations may perform additional operations, fewer operations, operations in parallel or in a different order, and some operations differently.

While the aspects of the disclosure are described with reference to various implementations and exploitations, it will be understood that these aspects are illustrative and that the scope of the claims is not limited to them. In general, techniques for performing NMR measurements and reducing motion artifacts from the NMR measurements as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

Furthermore, unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

### EXAMPLE EMBODIMENTS

Example Embodiments can include the following:

Embodiment #1: A method for obtaining nuclear magnetic resonance (NMR) measurements of a subsurface formation in a well system, comprising: determining NMR echo data having motion artifacts in response to performing downhole NMR measurements using an NMR tool of the well system; determining motion data from one or more downhole well devices of the well system, the motion data indicating a motion downhole of the NMR tool; providing the NMR echo data having the motion artifacts and the motion data as inputs to a trained machine learning system to reduce the motion artifacts of the NMR echo data; and obtaining output NMR echo data having reduced motion artifacts from an output of the trained machine learning system.

Embodiment #2: The method of Embodiment #1, further comprising: determining properties of the subsurface formation from the NMR echo data having the reduced motion artifacts.

Embodiment #3: The method of Embodiment #2, further comprising: modifying at least one of a well operation or a well operation attribute based on the determined properties of the subsurface formation.

Embodiment #4: The method of Embodiment #1, further comprising training a machine learning system to obtain the trained machine learning system, wherein the training includes: providing synthetic NMR data and synthetic motion data as inputs to the machine learning system to train the machine learning system.

Embodiment #5: The method of Embodiment #4, wherein the synthetic NMR data includes at least one of NMR echo waveforms, magnetic field data, acquisition window data, pulse type data, T1 data, T2 data, two dimensional T1-T2 data, diffusion-T1 data, diffusion-T2 data, or multidimensional D-T1-T2 data.

Embodiment #6: The method of Embodiment #4, wherein the synthetic motion data includes a motion displacement profile, the motion displacement profile includes at least one of a linear motion displacement profile, a circular motion displacement profile, a whirl motion displacement profile, or a random motion displacement profile.

Embodiment #7: The method of Embodiment #4, wherein training the machine learning system further includes using a loss function to train the machine learning system based on the synthetic motion data.

Embodiment #8: The method of Embodiment #1, further comprising training a machine learning system to obtain the trained machine learning system, wherein the training includes: providing synthetic and non-synthetic NMR data and synthetic and non-synthetic motion data as inputs to the machine learning system.

Embodiment #9: The method of Embodiment #8, wherein training the machine learning system further includes using a loss function to train the machine learning system based on the synthetic and non-synthetic motion data.

Embodiment #10: The method of Embodiment #8, wherein the non-synthetic motion data includes at least one of field motion data from at least one downhole well device that is in motion or field motion data from at least one downhole well device that is stationary.

Embodiment #11: The method of Embodiment #1, wherein the NMR echo data includes NMR echo waveform data or NMR echo train data.

Embodiment #12: The method of Embodiment #1, wherein the motion data includes at least one of acceleration data, acoustic data, velocity data, or NMR data used to derive the motion data.

Embodiment #13: The method of Embodiment #1, wherein the trained machine learning system is a trained generative machine learning system.

Embodiment #14: A well system for obtaining nuclear magnetic resonance (NMR) measurements of a subsurface formation, the well system comprising: one or more processors; and a computer-readable storage medium having instructions stored thereon that are executable by the one or more processors to cause the well system to: determine NMR echo data having motion artifacts in response to performance of downhole NMR measurements using an NMR tool of the well system; determine motion data from one or more downhole well devices of the well system, the motion data indicating a motion downhole of the NMR tool; provide the NMR echo data having the motion artifacts and the motion data as inputs to a trained machine learning system to reduce the motion artifacts of the NMR echo data; and obtain output NMR echo data having reduced motion artifacts from an output of the trained machine learning system.

Embodiment #15: The well system of Embodiment #14, further comprising instructions that are executable by the one or more processors to cause the well system to: determine properties of the subsurface formation from the NMR echo data having the reduced motion artifacts.

Embodiment #16: The well system of Embodiment #14, further comprising instructions that are executable by the one or more processors to cause the well system to: train a machine learning system to obtain the trained machine learning system, wherein the training includes providing synthetic NMR data and synthetic motion data as inputs to the machine learning system to train the machine learning system.

Embodiment #17: The well system of Embodiment #16, wherein the synthetic NMR data includes at least one of NMR echo waveforms, magnetic field data, acquisition window data, pulse type data, T1 data, T2 data, two dimensional T1-T2 data, diffusion-T1 data, diffusion-T2 data, or multidimensional D-T1-T2 data.

Embodiment #18: The well system of Embodiment #16, wherein the synthetic motion data includes a motion displacement profile, the motion displacement profile includes at least one of a linear motion displacement profile, a circular motion displacement profile, a whirl motion displacement profile, or a random motion displacement profile.

Embodiment #19: The well system of Embodiment #14, further comprising instructions that are executable by the one or more processors to cause the well system to: train a machine learning system to obtain the trained machine learning system, wherein the training includes providing synthetic and non-synthetic NMR data and synthetic and non-synthetic motion data as inputs to the machine learning system.

Embodiment #20: A non-transitory computer-readable storage medium having instructions stored thereon that are executable by one or more processors of a well system, the well system for obtaining nuclear magnetic resonance (NMR) measurements of a subsurface formation, the instructions comprising: instructions for determining NMR echo data having motion artifacts in response to performing downhole NMR measurements using an NMR tool of the well system; instructions for determining motion data from one or more downhole well devices of the well system, the motion data indicating a motion downhole of the NMR tool; instructions for providing the NMR echo data having the motion artifacts and the motion data as inputs to a trained machine learning system to reduce the motion artifacts of the NMR echo data; and instructions for obtaining output NMR echo data having reduced motion artifacts from an output of the trained machine learning system.

Embodiment #21: The non-transitory computer-readable storage medium of Embodiment #20, further comprising: instructions for determining properties of the subsurface formation from the NMR echo data having the reduced motion artifacts.

Embodiment #22: The non-transitory computer-readable storage medium of Embodiment #20, further comprising: instructions for training a machine learning system to obtain the trained machine learning system, wherein the training includes providing synthetic NMR data and synthetic motion data as inputs to the machine learning system to train the machine learning system.

Embodiment #23: The non-transitory computer-readable storage medium of Embodiment #20, further comprising: instructions for training a machine learning system to obtain the trained machine learning system, wherein the training includes providing synthetic and non-synthetic NMR data and synthetic and non-synthetic motion data as inputs to the machine learning system.

What is claimed is:

1. A method for obtaining nuclear magnetic resonance (NMR) measurements of a subsurface formation in a well system, comprising:
determining NMR echo data having motion artifacts in response to performing downhole NMR measurements using an NMR tool of the well system;
determining motion data from one or more downhole well devices of the well system, the motion data indicating a motion downhole of the NMR tool;
providing the NMR echo data having the motion artifacts and the motion data as inputs to a trained machine learning system to reduce the motion artifacts of the NMR echo data; and
obtaining output NMR echo data having reduced motion artifacts from an output of the trained machine learning system.

2. The method of claim 1, further comprising:
determining properties of the subsurface formation from the NMR echo data having the reduced motion artifacts.

3. The method of claim 2, further comprising:
modifying at least one of a well operation or a well operation attribute based on the determined properties of the subsurface formation.

4. The method of claim 1, further comprising training a machine learning system to obtain the trained machine learning system, wherein the training includes:
providing synthetic NMR data and synthetic motion data as inputs to the machine learning system to train the machine learning system.

5. The method of claim 4, wherein the synthetic NMR data includes at least one of NMR echo waveforms, magnetic field data, acquisition window data, pulse type data, T1 data, T2 data, two dimensional T1-T2 data, diffusion-T1 data, diffusion-T2 data, or multidimensional D-T1-T2 data.

6. The method of claim 4, wherein the synthetic motion data includes a motion displacement profile, the motion displacement profile includes at least one of a linear motion displacement profile, a circular motion displacement profile, a whirl motion displacement profile, or a random motion displacement profile.

7. The method of claim 4, wherein training the machine learning system further includes using a loss function to train the machine learning system based on the synthetic motion data.

8. The method of claim 1, further comprising training a machine learning system to obtain the trained machine learning system, wherein the training includes:
providing synthetic and non-synthetic NMR data and synthetic and non-synthetic motion data as inputs to the machine learning system.

9. The method of claim 8, wherein training the machine learning system further includes using a loss function to train the machine learning system based on the synthetic and non-synthetic motion data.

10. The method of claim 8, wherein the non-synthetic motion data includes at least one of field motion data from at least one downhole well device that is in motion or field motion data from at least one downhole well device that is stationary.

11. The method of claim 1, wherein the NMR echo data includes NMR echo waveform data or NMR echo train data.

12. The method of claim 1, wherein the motion data includes at least one of acceleration data, acoustic data, velocity data, or NMR data used to derive the motion data.

13. The method of claim 1, wherein the trained machine learning system is a trained generative machine learning system.

14. A well system for obtaining nuclear magnetic resonance (NMR) measurements of a subsurface formation, the well system comprising:
one or more processors; and
a computer-readable storage medium having instructions stored thereon that are executable by the one or more processors to cause the well system to:
determine NMR echo data having motion artifacts in response to performance of downhole NMR measurements using an NMR tool of the well system;
determine motion data from one or more downhole well devices of the well system, the motion data indicating a motion downhole of the NMR tool;
provide the NMR echo data having the motion artifacts and the motion data as inputs to a trained machine learning system to reduce the motion artifacts of the NMR echo data; and
obtain output NMR echo data having reduced motion artifacts from an output of the trained machine learning system.

15. The well system of claim 14, further comprising instructions that are executable by the one or more processors to cause the well system to:
determine properties of the subsurface formation from the NMR echo data having the reduced motion artifacts.

16. The well system of claim 14, further comprising instructions that are executable by the one or more processors to cause the well system to:
train a machine learning system to obtain the trained machine learning system, wherein the training includes providing synthetic NMR data and synthetic motion data as inputs to the machine learning system to train the machine learning system.

17. The well system of claim 16, wherein the synthetic NMR data includes at least one of NMR echo waveforms, magnetic field data, acquisition window data, pulse type data, T1 data, T2 data, two dimensional T1-T2 data, diffusion-T1 data, diffusion-T2 data, or multidimensional D-T1-T2 data.

18. The well system of claim 16, wherein the synthetic motion data includes a motion displacement profile, the motion displacement profile includes at least one of a linear motion displacement profile, a circular motion displacement profile, a whirl motion displacement profile, or a random motion displacement profile.

19. The well system of claim 14, further comprising instructions that are executable by the one or more processors to cause the well system to:
train a machine learning system to obtain the trained machine learning system, wherein the training includes providing synthetic and non-synthetic NMR data and synthetic and non-synthetic motion data as inputs to the machine learning system.

20. A non-transitory computer-readable storage medium having instructions stored thereon that are executable by one or more processors of a well system, the well system for obtaining nuclear magnetic resonance (NMR) measurements of a subsurface formation, the instructions comprising:
instructions for determining NMR echo data having motion artifacts in response to performing downhole NMR measurements using an NMR tool of the well system;
instructions for determining motion data from one or more downhole well devices of the well system, the motion data indicating a motion downhole of the NMR tool;
instructions for providing the NMR echo data having the motion artifacts and the motion data as inputs to a trained machine learning system to reduce the motion artifacts of the NMR echo data; and
instructions for obtaining output NMR echo data having reduced motion artifacts from an output of the trained machine learning system.

21. The non-transitory computer-readable storage medium of claim 20, further comprising:
instructions for determining properties of the subsurface formation from the NMR echo data having the reduced motion artifacts.

22. The non-transitory computer-readable storage medium of claim 20, further comprising:
instructions for training a machine learning system to obtain the trained machine learning system, wherein the training includes providing synthetic NMR data and synthetic motion data as inputs to the machine learning system to train the machine learning system.

23. The non-transitory computer-readable storage medium of claim 20, further comprising:
instructions for training a machine learning system to obtain the trained machine learning system, wherein the training includes providing synthetic and non-synthetic NMR data and synthetic and non-synthetic motion data as inputs to the machine learning system.
